(19) United States
(12) Patent Application Publication
(10) Pub. No.: US 2011/0132517 A1
(43) Pub. Date: Jun. 9, 2011

(54) METHOD OF FORMING DEVICES HAVING PLASTIC SUBSTRATES

(75) Inventors: Gi Heon Kim, Daejeon (KR); Yong Hae Kim, Daejeon (KR)

(73) Assignee: ELECTRONICS AND TELECOMMUNICATIONS RESEARCH INSTITUTE, Daejon (KR)

(21) Appl. No.: 12/764,778

(22) Filed: Apr. 21, 2010

(30) Foreign Application Priority Data
Dec. 4, 2009 (KR) 10-2009-0119768

(51) Int. Cl. B29C 65/02

(52) U.S. Cl. 156/60

(57) ABSTRACT

Provided is a method of forming a device having a plastic substrate. The method forming the plastic substrate, thermally processing the plastic substrate, and applying the thermally treated plastic substrate to the device.

### CROSS-REFERENCE TO RELATED APPLICATIONS

This U.S. non-provisional patent application claims priority under 35 U.S.C. §119 of Korean Patent Application No. 10-2009-0119768, filed on Dec. 4, 2009, the entire contents of which are hereby incorporated by reference.

### BACKGROUND

The present invention disclosed herein relates to a method of forming devices having plastic substrates.

Recently, with the growing interest in a flexible device, technologies related to the flexible devices are being developed. A panel display using an inorganic material such as a typical glass substrate does not have the flexible characteristic while a plastic substrate containing an organic material may have the flexible characteristic to realize the flexible device.

However, there are limitations that plastic substrates are susceptible to heat and have poor uniformity when compared to substrates formed using inorganic materials.

### SUMMARY

The present invention provides a method of forming a device including a plastic substrate having improved uniformity.

The present invention also provides a method of forming a device including a plastic substrate having improved physical properties.

Embodiments of the present invention provide methods of forming a device with a plastic substrate including: forming the plastic substrate; thermally processing the plastic substrate; and applying the thermally treated plastic substrate to the device.

In some embodiments, the plastic substrate may include the polymers having glass transition temperatures Tg of less than about 30° C., wherein the thermally processing of the plastic substrate may include supplying heat having a temperature ranging from about (Tg−100)° C. to about (Tg+100)° C. to the plastic substrate.

In other embodiments, the plastic substrate may include the polymers having glass transition temperatures Tg of greater than about 30° C. The thermally processing of the plastic substrate may include supplying heat having a temperature ranging from about (Tg−150)° C. to about Tg to the plastic substrate.

In still other embodiments, the thermally processing of the plastic substrate may be performed for a time ranging from about 10 minutes to about 8 hours.

In even other embodiments, the thermally processing of the plastic substrate may include heating the plastic substrate and cooling the plastic substrate. In this case, the heating and cooling of the plastic substrate may be alternately performed several times.

The sum of the times for which the heating process may be repeatedly performed is in the range of from 10 minutes to about 8 hours. The heating and cooling processes may be repeatedly performed 2 times to 10 times.

In yet other embodiments, the thermally processing of the plastic substrate may include heating the plastic substrate continuously.

In further embodiments, the thermally processing of the plastic substrate may include heating an entire surface of any one surface of an upper surface and a lower surface of the plastic substrate.

In still further embodiments, the thermally processing of the plastic substrate may includes heating the entire surface of any one surface of the upper surface and the lower surface of the plastic substrate and heating a portion of the other surface of the upper surface and the lower surface.

The components of the device may be formed on the surface which is heated.

In yet further embodiments, the applying of the plastic substrate to the device may include forming components of the device on the plastic substrate and thermally processing the device to which the plastic substrate is applied.

In much further embodiments, the applying of the plastic substrate to the device may include forming a transistor on the plastic substrate.

In still much further embodiments, the applying of the plastic substrate to the device may include forming a coating layer on the plastic substrate and thermally processing the coating layer.

In even much further embodiments, the thermally processing of the plastic substrate may include heating through a temperature control plate disposed in a region adjacent to the plastic substrate. In this case, a distance between the temperature control plate and the plastic substrate may be within about 10 cm. For example, the temperature control plate may be closely attached to the plastic substrate.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a schematic process diagram for explaining a method of forming a device including a plastic substrate according to an embodiment of the present invention;

FIG. 2 is a perspective view for explaining a method of forming a device including a plastic substrate according to an embodiment of the present invention;

FIG. 3 is a perspective view for explaining a method of forming a device including a plastic substrate according to another embodiment of the present invention;

FIGS. 4 and 5 are graphs illustrating a process temperature according to the embodiments according to the present invention; and

FIG. 6 is a flowchart for explaining a method of forming a device including a plastic substrate according to the embodiments according to the present invention.

### DETAILED DESCRIPTION OF EMBODIMENTS

Preferred embodiments of the present invention will be described below in more detail with reference to the accompanying drawings. These embodiments are provided so that this disclosure will be thorough and complete, and will fully convey the scope of the present invention to those skilled in the art. The present invention may be embodied in different forms and should not be constructed as limited to the embodiments set forth herein. As used herein, the term and/or includes any and all combinations of one or more of the associated listed items. It will also be understood that when a layer (or film) is referred to as being ‘on’ another layer or substrate, it can be directly on the other layer or substrate, or intervening layers may also be present. Further, it will be understood that when a layer is referred to as being ‘under’ another layer, it can be directly under, and one or more intervening layers may also be present. In addition, it will also be understood that when a layer is referred to as being ‘between’ two layers, it can be the only layer between the two layers, or one or more intervening layers may also be present. It will be understood that although the terms first and second are used herein to describe various elements, these elements should not be limited by these terms. In the drawings, the dimensions of layers and regions are exaggerated for clarity of illustration.

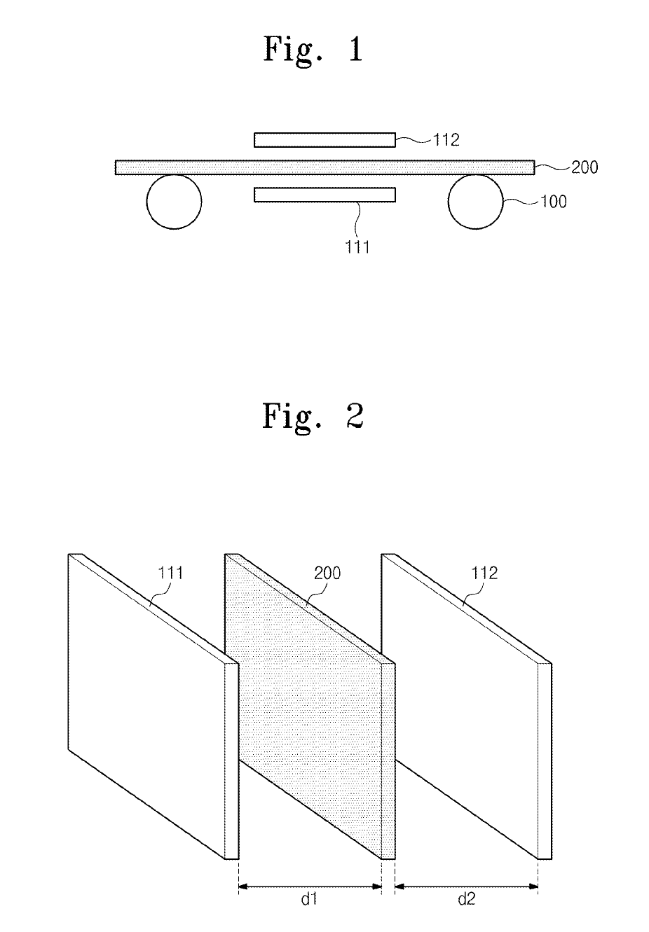

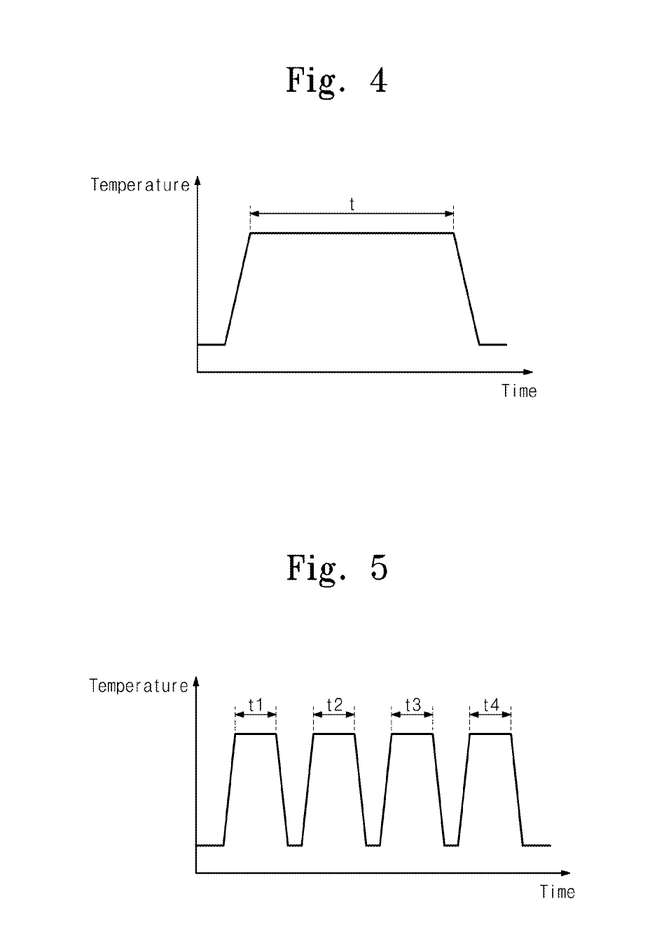

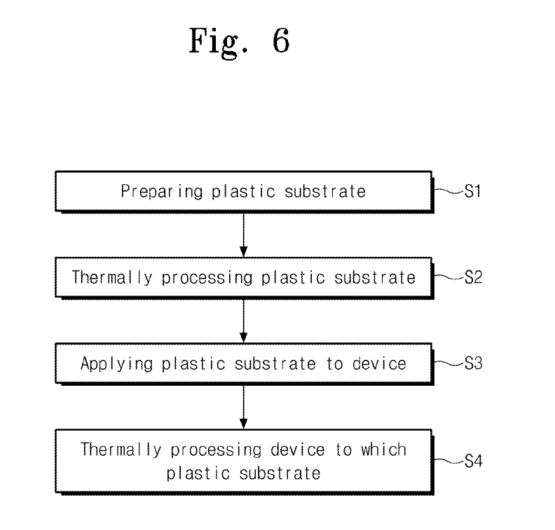

Hereinafter, a method of forming a device including a plastic substrate according to embodiments of the present invention will be described with reference to FIGS. 1, 2, and 4 to 6. FIG. 1 is a schematic process diagram for explaining a method of forming a device including a plastic substrate according to an embodiment of the present invention, and FIG. 2 is a perspective view for explaining a method of forming a device including a plastic substrate according to an embodiment of the present invention. FIGS. 4 and 5 are graphs illustrating a process temperature according to the embodiments according to the present invention. FIG. 6 is a flowchart for explaining a method of forming a device including a plastic substrate according to the embodiments according to the present invention.

Referring to FIGS. 1 and 6, a plastic substrate 200 is prepared in operation 51. The plastic substrate 200 may be formed of at least one polymer of polycarbonate (PC), polyethylene terephthalate (PET), polyetheretherketone (PEEK), polyethylene naphthalate (PEN), polyether sulfone (PES), and cyclic olefin copolymer (COC), which have a glass transition temperature Tg less than about 300° C. Alternatively, the plastic substrate 200 may be formed of at least one polymer of polyimide (PI), poly(norbonene) (PNB), and polyarylite (PAL), which have a glass transition temperature Tg equal to or greater than about 300° C.

A process of forming the plastic substrate 200 may include a thermal process. Hereinafter, the thermal process for forming the plastic substrate 200 will now be referred to as a formation thermal-process. The formation thermal-process may be a process for polymerizing polymers constituting the plastic substrate 200. That is, the formation thermal-process may be a thermal process performed before the plastic substrate 200 is finally formed and/or during the formation of the plastic substrate 200.

The plastic substrate 200 is supported by a support 100. The support 100 may be a unit for disposing the plastic substrate 200 at a position at which heat is effectively supplied to the plastic substrate 200. Thus, the support 100 may be varied into various configurations different from those illustrated in the drawings. Also, the support 100 may have a roller shape to move the plastic substrate 200. In this case, the plastic substrate 200 may be treated by a roll-to-roll process.

Temperature control plates 111 and 112 are disposed in regions adjacent to an upper surface and a lower surface of the plastic substrate 200 supported by the support 100. The temperature control plates 111 and 112 include a lower temperature control plate 111 disposed below the lower surface of the plastic substrate 200 and an upper temperature control plate 112 disposed above the upper surface of the plastic substrate 200. The lower temperature control plate 111 may be configured to supply heat to the lower surface of the plastic substrate 200, and the upper temperature control plate 112 may be configured to supply heat to the upper surface of the plastic substrate 200. In one embodiment, the upper and lower temperature control plates 111 and 112 may be configured to cool the plastic substrate. That is, the temperature control plates 111 and 112 may be units configured to control a processing temperature of the plastic substrate 200.

Referring to FIG. 2, the upper and lower temperature control plates 111 and 112 may have plate shapes, respectively. Entire surfaces of the plastic substrate 200 covered by the upper and lower temperature control plates 111 and 112 may be heated or cooled at the same time. Although not depicted in figure, any one of the upper and lower temperature control plates 111 and 112 may be omitted.

A distance d1 between the lower temperature control plate 111 and the plastic substrate 200 may be less than about 10 cm. Also, a distance d2 between the upper temperature control plate 112 and the plastic substrate 200 may be less than about 10 cm. The heat supplied to the plastic substrate 200 may be effectively controlled by the distances d1 and d2.

In operation S2, a thermal process is performed on the plastic substrate 200 using the upper and lower temperature control plates 111 and 112. The thermal process is performed after the plastic substrate 200 is formed. Also, the thermal process represents a separate thermal process distinguished from the formation thermal-process. Hereinafter, the thermal process performed after formation of the plastic substrate 200 will now be referred to as a post-formation thermal-process.

The post-formation thermal-process may include heating the plastic substrate 200. The thermal process may be performed by increasing temperatures of the temperature control plates 111 and 112. The thermal process includes heating the plastic substrate 200 in a temperature range from about (Tg−150)° C. to about (Tg+100)° C. Here, the reference symbol Tg represents glass transition temperatures of the polymers contained in the plastic substrate 200.

The plastic substrate 200 may be heated at different temperatures according to kinds of the polymers contained in the plastic substrate 200. For example, when the plastic substrate 200 includes the polymers having a glass transition temperature Tg of less than about 300° C., the plastic substrate 200 may be heated at a temperature ranging from about (Tg−100)° C. to about (Tg+100)° C. For another example, when the plastic substrate 200 includes the polymers having a glass transition temperature Tg of greater than about 300° C., the plastic substrate 200 may be heated at a temperature ranging from about (Tg−150)° C. to about Tg ° C.

Referring to FIGS. 1 and 2, the plastic substrate 200 may be thermally treated by the roll-to-roll process in which the plastic substrate 200 sequentially passes between the temperature control plates 111 and 112 on the support 100.

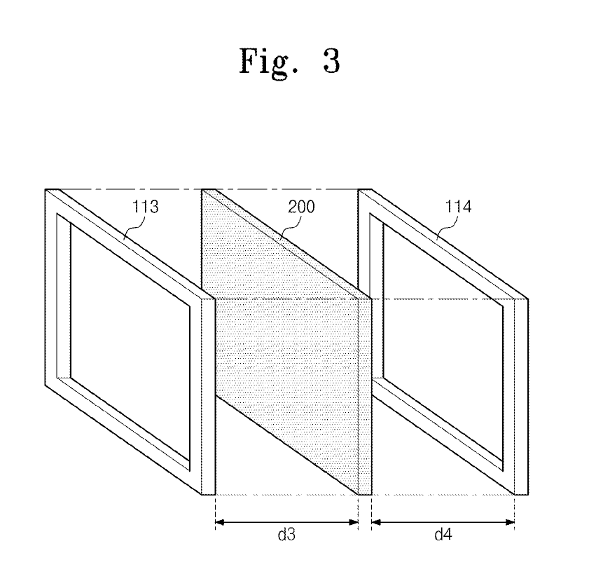

Alternatively, the post-formation thermal-process may be performed using a batch process. Referring to FIG. 3, temperature control plates 113 and 114 contact the plastic substrate 200 are disposed. The temperature control plates 113 and 114 may be disposed to cover entire surfaces of upper and lower surfaces of the plastic substrate 200. The temperature control plates 113 and 114 may be closely attached to the plastic substrate 200. The temperature control plates 113 and 114 may be closely attached to the plastic substrate 200 through a compression process or by external components such as a bolt. That is, distances d3 and d4 between the temperature control plates 113 and 114 and the plastic substrate 200 may be substantially zero.

In an embodiment, the temperature control plates 113 and 114 may be open types, i.e., have a configuration in which the temperature control plates 113 and 114 cover only a portion of any one surface of the upper and lower surfaces of the plastic substrate 200. On the other hand, one of the temperature control plates 113 and 114 may be a closed type, i.e., have a configuration in which the temperature control plates 113 and 114 cover an entire surface of any one surface of the upper and lower surfaces of the plastic substrate 200, and the other of the temperature control plates 113 and 114 may be the open type. The surface of the plastic substrate 200 exposed by the open type temperature control plate 113 may be a surface on which a device process will be performed later. Alternatively, all of the temperature control plates 113 and 114 used for the batch process may be the closed types.

Referring to FIG. 4, the plastic substrate 200 may be heated for a predetermined time t. The plastic substrate 200 may be heated for a time t ranging from about 10 minutes to about 8 hours. As shown in FIG. 4, the plastic substrate 200 may be sequentially heated. For example, heat may be supplied to the plastic substrate 200 for a continuous time. In an embodiment, the plastic substrate 200 may be heated in a constant temperature. Alternatively, the plastic substrate 200 may be heated under varied temperature within predeterminded temperature range.

Referring to FIG. 5, the plastic substrate 200 may be discontinuously heated. For example, the heating and cooling of the plastic substrate 200 may be alternately performed several times. In an embodiment, the heating and cooling of the plastic substrate 200 may be repeated about 2 times to about 10 times. At this time, the total sum t1+t2+t3+t4 of discontinuous heating times may be in the range of from 10 minutes to about 8 hours. At this time, the temperature control plates 111 and 112 may increase in temperature to heat the plastic substrate 200. The temperature control plates 111 and 112 may decrease in temperature or be spaced from the plastic substrate 200 to cool the plastic substrate 200. When the temperature control plates 111 and 112 decrease in temperature to cool the plastic substrate 200, it may be possible to respectively install a heater and cooler on upper and lower portions of the temperature control plates 111 and 112.

The post-formation thermal-process may be performed to improve physical properties and thermal stability. For example, the post-formation thermal-process may be performed to remove impurities (e.g., volatile gases) between the polymers of the plastic substrate 200. As a result, packing density of the polymers may be improved. For another example, the post-formation thermal-process may be performed to rearrange the polymers contained in the plastic substrate 200. Thus, uniformity of the plastic substrate 200 may be improved. The uniformity and thermal stability of the plastic substrate 200 may be improved by various factors including the above-described examples. Since the post-formation thermal-process is performed before different components of a device of the plastic substrate 200 are formed, the different components may be formed on the plastic substrate 200 having the improved characteristics. Thus, physical and electrical properties of the different components to be formed later may be improved together with the plastic substrate 200 having the improved characteristics.

In operation S3, the thermally treated plastic substrate 200 is applied to a device. The device may be applicable to at least one selected from various devices including a thin film transistor (TFT), a solar cell, a display, and a touch screen. Applying the plastic substrate 200 to the device includes forming different components on the plastic substrate 200 and introducing the plastic substrate 200 within a device in which different components are formed. In addition, applying the plastic substrate 200 includes also forming predetermined components on the plastic substrate 200 to form a device, and combining the formed device with another components.

After the plastic substrate 200 is applied, a thermal process may be performed on the plastic substrate 20 applied to the device in operation S4. For distinguishing this thermal process from the previously described thermal process, the process for thermally treating the plastic substrate 200 applied to the device will be referred to as a device thermal-process. For example, the device thermal-process may include forming a coating layer on the plastic substrate 200 to thermally treat the plastic substrate 200 on which the coating layer is formed. The coating layer may be formed of an organic material, an inorganic material, or a combination thereof. The coating layer may be a layer for improving physical and/or electrical properties of the plastic substrate 200. For another example, the device thermal-process may include applying heat to the plastic substrate 200 to form components of a transistor in a process of forming the transistor on the plastic substrate 200. The device thermal-process is performed on the plastic substrate 200 applied to the device. Thus, the device thermal-process is distinguished from the post-formation thermal-process in which the thermal process is performed before the plastic substrate 200 is applied to the device.

Hereinafter, improved characteristics of the plastic substrate formed according to the embodiments of the present invention will be described. In this experimental example, a polyarylite substrate having a size of about 25×25 cm² was used as a plastic substrate. In this experimental example, the plastic substrate was thermally treated using an apparatus illustrated in FIG. 1. Three plastic substrates were prepared. One of the three plastic substrates was used as a comparison group. A thermal process was not performed on the plastic substrate (hereinafter, referred to as a substrate A) used as the comparison group. A thermal process was performed on one plastic substrate (hereinafter, referred to as substrates B) of the remaining two plastic substrates for about 2 hours under the temperature condition of about 220° C. The substrate B was continuously heated for about 2 hours. Particularly, as shown in FIG. 4, heat having a temperature of about 220° C. was continuously supplied to the substrate B. A post-formation thermal-process was performed on the other plastic substrate (hereinafter, referred to as a substrate C) under the temperature condition of about 220° C. Particularly, as shown in FIG. 5, heating and cooling processes were alternately and repeatedly performed. The heating process was performed 8 times on the substrate C. Also, the heating process was performed for about 2 hours.

The substrates A, B, and C are respectively cut into a size of about 10×10 mm² Coefficients of linear thermal expansion (CTEs) of the cut substrates A, B, and C are measured using a Q-400 that is a CTE measurement device. According to the measured results, the substrate A has a CTE of about 88 ppm/° C. to about 110 ppm/° C. On the other hand, the substrates B and C thermally treated according to the embodiments of the present invention have a CTE of about 74 ppm/° C. to about 88 ppm/° C. and a CTE of about 74 ppm/° C. to about 79 ppm/° C., respectively. That is, it may be seen that the CTEs of the substrates B and C are improved.

In addition, another experimental example for explaining the other effect of the embodiments of the present invention will be described. In this experimental example, a polyimide substrate was used as a plastic substrate. Like the previously described experimental example, the post-formation thermal-process according to the embodiments of the present invention was not performed on a portion (substrate A) of the plastic substrates. On the other hand, the post-formation thermal-process was performed on the other portion (substrate B) of the plastic substrates as described with reference to FIG. 3. As shown in FIG. 4, heat was continuously supplied to the substrate B. Also, the post-formation thermal-process was performed on the other portion (substrate C) of the plastic substrates as described with reference to FIG. 2. The post-formation thermal-processes were performed for about 8 hours on the substrates B and C, respectively.

The substrates A, B, and C are respectively cut into a size of about 10×10 mm² Heat having a temperature of about 150° C. is supplied to the cut substrates A, B, and C. Dimensional changes of the substrates A, B, and C to which the heat is supplied are measured according to a time. The measured dimensional changes of the substrates A, B, and C are given in the following table.

| | 1 hour | 2 hours | 4 hours | 6 hours |
|---|---|---|---|---|
| Substrate A | 0.03~0.32% | 0.03~0.11% | 0.02~0.08% | 0.01~0.08% |
| Substrate B | 0.03~0.13% | 0.01~0.06% | 0.01~0.06% | 0.01~0.04% |
| Substrate C | 0.02~0.10% | 0.01~0.05% | 0.01~0.05% | 0.01~0.02% |

According to the measured results, the substrates B and C thermally treated according to the embodiments of the present invention have dimensional changes less than that of the non-treated substrate A. That is, it may be seen that the plastic substrate thermally treated according to the embodiments of the present invention have the improved thermal stability.

According to the embodiments of the present invention, the heat is supplied to the plastic substrate to improve the uniformity of the plastic substrate. Also, the plastic substrate may have the improved thermal stability.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of forming a device with a plastic substrate, the method comprising:
forming the plastic substrate comprising polymers having predetermined glass transition temperatures Tg;
thermally processing the plastic substrate; and
applying the thermally treated plastic substrate to the device,
wherein the thermally processing of the plastic substrate comprises heating the plastic substrate in ranging from about (Tg−150)° C. to about (Tg+100)° C.

2. The method of claim 1, wherein the plastic substrate comprises the polymers having glass transition temperatures Tg of less than about 300° C.,
wherein the thermally processing of the plastic substrate comprises heating the substrate in ranging from about (Tg−100)° C. to about (Tg+100)° C.

3. The method of claim 1, wherein the plastic substrate comprises the polymers having glass transition temperatures Tg of equal to or greater than about 300° C., and
wherein the thermally processing of the plastic substrate comprises heating the plastic substrate in ranging from about (Tg−150)° C. to about Tg.

4. The method of claim 1, wherein the thermally processing of the plastic substrate is performed for a time ranging from about 10 minutes to about 8 hours.

5. The method of claim 1, wherein the thermally processing of the plastic substrate comprises heating to the plastic substrate to heat the plastic substrate and cooling the plastic substrate,
wherein the heating and cooling of the plastic substrate are alternately performed several times.

6. The method of claim 5, wherein the sum of the times for which the heating process is repeatedly performed is in the range of from 10 minutes to about 8 hours.

7. The method of claim 5, wherein the heating and cooling processes are repeatedly performed 2 times to 10 times.

8. The method of claim 1, wherein the thermally processing of the plastic substrate comprises heating the plastic substrate continously.

9. The method of claim 1, wherein the thermally processing of the plastic substrate comprises heating an entire surface of any one surface of an upper surface and a lower surface of the plastic substrate.

10. The method of claim 9, wherein the thermally processing of the plastic substrate comprises heating the entire surface of any one surface of the upper surface and the lower surface of the plastic substrate and heating a portion of the other surface of the upper surface and the lower surface.

11. The method of claim 10, wherein components of the device are formed on the surface on which the heat is supplied to a portion of the upper surface and the lower surface.

12. The method of claim 1, wherein the applying of the plastic substrate to the device comprises forming components of the device on the plastic substrate and thermally processing the device to which the plastic substrate is applied.

13. The method of claim 1, wherein the applying of the plastic substrate to the device comprises forming a transistor on the plastic substrate.

14. The method of claim 1, wherein the applying of the plastic substrate to the device comprises forming a coating layer on the plastic substrate and thermally processing the coating layer.

15. The method of claim 1, wherein the thermally processing of the plastic substrate is heated by a temperature control plate adjacent to the plastic substrate,
wherein a distance between the temperature control plate and the plastic substrate is within about 10 cm.

16. The method of claim 15, wherein the temperature control plate is closely attached to the plastic substrate.
